(19) United States
(12) Patent Application Publication
(10) Pub. No.: US 2014/0056583 A1
(43) Pub. Date: Feb. 27, 2014

(54) SYMBOL ALIGNMENT IN HIGH SPEED OPTICAL ORTHOGONAL FREQUENCY DIVISION MULTIPLEXING TRANSMISSION SYSTEMS

(71) Applicants: Roger Giddings, Tregarth (GB); Jianming Tang, Chelmsford (GB)

(72) Inventors: Roger Giddings, Tregarth (GB); Jianming Tang, Chelmsford (GB)

(21) Appl. No.: 14/009,978

(22) PCT Filed: Apr. 4, 2012
(86) PCT No.: PCT/EP12/56244

§ 371 Date: Oct. 28, 2013

(30) Foreign Application Priority Data
Apr. 6, 2011 (GB) 1105808.8

(51) Int. Cl. H04L 27/26; H04J 14/00

(52) U.S. Cl. CPC H04L 27/2601; H04J 14/00
USPC 398/44; 398/79

(57) ABSTRACT

The present invention discloses a method for symbol synchronisation in high speed optical orthogonal frequency division multiplexing (OOFDM) transmission systems via coding the electrical OFDM symbols by adding an independent low power-level alignment signal, converting the encoded signal into the optical domain for transmission, and in the receiver converting the received optical signal to the electrical domain and digitally processing to detect the symbol alignment offset by utilising the independent low-power level alignment signal. The present invention is suitable for point-to-point and point-to-multi-point OOFDM networks and has the additional features of timeslot and frame alignment, compensation for receiver sampling clock offset and providing physical layer network security. The superimposed training signal is a DC offset whose value varies at symbol transitions.

### FIELD OF THE INVENTION

The present invention discloses a technique based on a Digital Signal Processing (DSP) algorithm using symbol DC offset signalling to enable symbol alignment and introduce extra physical layer network security in high speed optical orthogonal frequency division multiplexing (OOFDM) transmission systems.

### DESCRIPTION OF THE RELATED ART

It is known to use optical orthogonal frequency division multiplexing (OOFDM) modulation technique in order to reduce optical modal dispersion in multimode fibre (MMF) transmission links, as disclosed for example in Jolley et al. (N. E. Jolley, H. Kee, R. Richard, J. Tang, K. Cordina, presented at the National Fibre Optical Fibre Engineers Conf., Annaheim, Calif., Mar. 11, 2005, Paper OFP3). It also offers the advantages of great resistance to chromatic dispersion impairments, efficient use of channel spectral characteristics, excellent cost-effectiveness due to full use of mature digital signal processing (DSP), provision of hybrid dynamic bandwidth allocation in both the frequency and time domains, and significant reduction in optical network complexity.

It can also be used advantageously for dispersion compensation and high spectral efficiency in single mode fibre (SMF)-based long distance transmission systems such as described for example by Lowery et al. (A. J. Lowery, L. Du, J. Armstrong, presented at the National Fibre Optical Fibre Engineers Conf., Annaheim, Calif., Mar. 5, 2006, paper PDP39) or by Djordjevic and Vasic (I. B. Djordjevic and B. Vasic, in Opt. express, 14, n° 9, 37673775, 2006).

The transmission performance of OOFDM have been studied and reported for all the optical network scenarios including long-haul systems such as described for example in Masuda et al.(H. Masuda, E. Yamazaki, A. Sano, T. Yoshimatsu, T. Kobayashi, E. Yoshida, Y. Miyamoto, S. Matsuoka, Y. Takatori, M. Mizoguchi, K. Okada, K. Hagimoto, T. Yamada, and S. Kamei, “13.5-Tb/s (135×111-Gb/s/ch) no-guard-interval coherent OFDM transmission over 6248km using SNR maximized second-order DRA in the extended L-band,” Optical Fibre Communication/National Fibre Optic Engineers Conference (OFC/NFOEC), (OSA, 2009), Paper PDPB5) or in Schmidt et al. (B. J. C. Schmidt, Z. Zan, L. B. Du, and A. J. Lowery, “100 Gbit/s transmission using single-band direct-detection optical OFDM,” Optical Fibre Communication/National Fibre Optic Engineers Conference (OFC/NFOEC), (OSA, 2009), Paper PDPC3) or metropolitan area networks such as described for example in Duong et al. (T. Duong, N. Genay, P. Chanclou, B. Charbonnier, A. Pizzinat, and R. Brenot, “Experimental demonstration of 10 Gbit/s for upstream transmission by remote modulation of 1 GHz RSOA using Adaptively Modulated Optical OFDM for WDM-PON single fiber architecture,” European Conference on Optical Communication (ECOC), (Brussels, Belgium, 2008), PD paper Th.3.F.1) or in Chow et al. (C.-W. Chow, C.-H. Yeh, C.-H. Wang, F.-Y. Shih, C.-L. Pan and S. Chi, “WDM extended reach passive optical networks using OFDM-QAM,” Optics Express, 16, 12096-12101, July 2008) , or access networks such as described for example in Qian et al. (D. Qian, N. Cvijetic, J. Hu and T. wang, “108 Gb/s OFDMA-PON with polarization multiplexing and direct-detection,” Optical Fibre Communication/National Fibre Optic Engineers Conference (OFC/NFOEC), (OSA, 2009), Paper PDPD5) or in local area networks (LANs) such as described in Yang et al. (H. Yang, S. C. J. Lee, E. Tangdiongga, F. Breyer, S. Randel, and A. M. J. Koonen, “40-Gb/s transmission over 100 m graded-index plastic optical fibre based on discrete multitone modulation,” Optical Fibre Communication/National Fibre Optic Engineers Conference (OFC/NFOEC), (OSA, 2009), Paper PDPD8).

OOFDM data transmission sends data as groups of encoded bits: in the frequency domain each group of bits are subdivided and modulated onto a number of harmonically related carrier frequencies. In the time domain each group of encoded bits are represented by a real or complex analogue signal of fixed length, which is referred as to an OOFDM symbol. The transmitted signal consists of a continuous series of symbols with no clear distinction between the symbols. Each symbol may also include a cyclic prefix which is used to combat inter-symbol interference. For the transmission system to operate the receiver must be able to identify the symbol boundaries so that each symbol can be extracted from the continuous time domain signal and subsequently processed to recover the received data.

All prior art existing systems were based on off-line signal processing: in the transmitter, generally arbitrary waveform generators (AWGs) using off-line signal processing-generated waveforms produce OOFDM signals. At the receiver, the received OOFDM signals were captured by digital storage oscilloscopes (DSOs) and the captured OOFDM symbols were processed off-line to recover the received data, based on sophisticated pilot-tone autocorrelation synchronisation approach. Those off-line signal processing approaches do not consider the limitations imposed by the precision and speed of practical DSP hardware that are required for implementing real-time transmission.

Other works described for example in WO98/19410 or EP-A-840485, or U.S. Pat. No. 5,953,311 disclosed a method for determining the boundaries of guard intervals of data symbols received in a coded orthogonal frequency division multiplexed (OFDM) signal. In that method, temporal signals separated by an active interval of a data symbol were associated in pairs and difference signals obtained. The dispersion of a first and second comparison blocks of difference signal were compared wherein the second comparison block was displaced from the first comparison block by n samples.

In U.S. Pat. No. 5,555,833, the signals were formatted in symbol blocks wherein each block comprised redundant information. It also included means for delaying the symbol blocks and for subtracting said delayed symbol block from the corresponding symbol block. The difference signal was then used to control a loop comprising a local oscillator operating at the clock frequency.

In GB-A-2353680, synchronisation was achieved using a frame synchronisation pulse generated by deriving absolute values of successive complex samples of the OFDM symbol, determining the difference between these values and other values separated by a period representing the useful part of the OFDM symbol, integrating the differences over a plurality of symbols and determining the sample position of the point at which said integrated difference values changed substantially.

US2005/0276340 detected the symbol boundary timing in the receiver of a multicarrier system by:
receiving a series of received training signals over a wire-based channel;
storing at least 3 of these series to a buffer;
determining difference values of a pair of consecutive received training signals stored in the buffer;
selecting one of the difference values;
determining the received symbol boundary timing based on the selected difference value.

The known systems have been improved by introducing a signal modulation technique known as adaptively modulated OOFDM (AMOOFDM), offering extra advantages such as:
improved system flexibility, performance robustness and transmission capacity;
more efficient use of spectral characteristics of transmission links; individual subcarriers within a symbol can be modified according to needs in the frequency domain;
use of existing legacy multimode fibres (MMFs) or installed single mode fibre (SMF) plants;
further reduction in installation and maintenance cost.

These have been described and discussed for example in Tang et al. (J. Tang, P. M. Lane and K. A. Shore in IEEE Photon. Technol. Lett, 18, n° 1, 205-207, 2006 and in J. Lightw. Technol., 24, n° 1, 429-441, 2006) or in Tang and Shore (J. Tang and K. A. Shore, in J. Lightw. Technol., 24, n° 6, 2318-2327, 2006). Additional aspects such as
the impact of signal quantisation and clipping effects related to analogue to digital conversion (ADC) and determination of optimal ADC parameters;
maximisation of transmission performance; have also been described in Tang and Shore (J. Tang and K. A. Shore, in J. Lightw. Technol., 25, n° 3, 787-798, 2007).

OFDM has widely been used in wireless packet-based networks (e.g. WLAN), wireless broadcast systems (e.g. DAB, DVB-T, DVB-H) and wireline networks (e.g. ADSL and VDSL).

The continuous transmission networks have more relaxed timing requirements for synchronisation than the packet-based networks which have to synchronise each packet. In all the established OFDM transmission systems, the symbol synchronisation methods are all based on correlation of the received signal with a known signal or a delayed copy of the received signal. The receiver correlation process relies on patterns inserted in the transmitted signal such as training sequences, preambles or the symbol cyclic prefix. However, these approaches are not suitable for high speed OOFDM transmission systems having very high bit rates over 1000 times higher than non-optical OFDM.

Therefore, OOFDM is a contending advanced optical transmission technology for future optical networks. One key application is in passive optical network (PON)-based access networks, where optical fibres are installed between the telecom operator's central office (CO) and the end users' premises, typically known as fibre to the home (FTTH). The PON thus forms a point to multipoint network topology. OOFDM can be used in this topology with a single wavelength by using time division multiplexing (TDM) to allow the transmission bandwidth to be shared between different end users. For TDM to operate, the symbols originating from different end users must be aligned. In another embodiment, the bandwidth in an OOFDM based PON can be partitioned to allocate different subcarriers within the same symbol to different users. This set-up also requires symbol alignment between different end-users. OOFDM based systems that dynamically allocate bandwidth by using partitioning in the time domain (timeslots) and/or in the frequency domain (subcarriers) are known as OOFDM multiple access (OOFDMA) systems.

Symbol alignment is thus a crucial issue in all applications of OOFDM transmission systems.

In order to implement real-time DSP-based OOFDM transceivers in a cost efficient manner, there is a need to develop all required advanced high-speed signal processing algorithms with low complexity.

### SUMMARY OF THE INVENTION

It is an objective of the present invention to provide a method for symbol detection and alignment in point-to-point OOFDM transmission systems using coherent or direct detection.

It is also an objective of the present invention to provide a method for symbol detection and alignment in point-to-multipoint optical networks such as OOFDMA based networks using coherent or direct detection.

It is another objective of the present invention to provide a high speed, low-complexity OOFDM synchronisation technique for high capacity OOFDM transmission systems without using cyclic prefix.

It is yet another objective of the present invention to compensate sampling clock offset (SCO) and sampling time offset (STO) in the OOFDM receiver in intensity modulation and direct direction (IMDD) transmission systems.

It is a further objective of the present invention to allow full synchronisation of symbols, timeslots and frames in point-to-point and point-to-multipoint networks such as OOFDMA based networks suitable for multiple services and on-line upgrading and without any disruption to existing network traffic.

It is yet a further objective of the present invention to provide an extra level of system security at the physical layer by making the reception of communications virtually impossible by an unauthorised user due to the inability to achieve synchronisation.

It is also an objective of the present invention to achieve simple and fast tracking symbol synchronisation without consuming additional bandwidth.

It is another objective of the present invention to require only low cost optical and electrical components.

It is also an objective of the present invention to propose Media Access Control (MAC) layer network synchronisation protocols corresponding to OOFDMA PONs with the synchronisation technique.

The invention achieves any one or more of the foregoing objectives in a simple and effective manner without any degradation of all other aspects of network performance.

In accordance with the foregoing objectives, the present invention is carried out as recited in the independent claims. Preferred embodiments are described in the dependent claims.

### LIST OF FIGURES

FIG. 1a represents the system block diagram for the OOFDM downstream link in an optical network.

FIG. 1b represents the system block diagram for the OOFDM upstream link in an optical network.

FIG. 2 represents the symbols within an analogue OOFDM signal comprising a cyclic prefix having C samples and a data region having N samples.

FIG. 3 represents the signal waveform of a typical OOFDM signal combined with an alignment signal.

FIG. 4 represents a typical calculation of correlation sum over one cycle of the correlation signal, for an arbitrary offset w.

FIG. 5 represents the variation of INTᵥ as a function of correlation signal offset v.

FIG. 6 represents a basic PON architecture showing upstream symbol alignment. In this figure one symbol is shown as one timeslot.

### DETAILED DESCRIPTION OF THE PRESENT INVENTION.

Accordingly, the present invention discloses a method for symbol synchronisation in high speed OOFDM transmission systems consisting of coding the electrical OFDM symbols by adding an independent low power-level alignment signal and converting the combined signal into the optical domain using electrical to optical (E/O) converter.

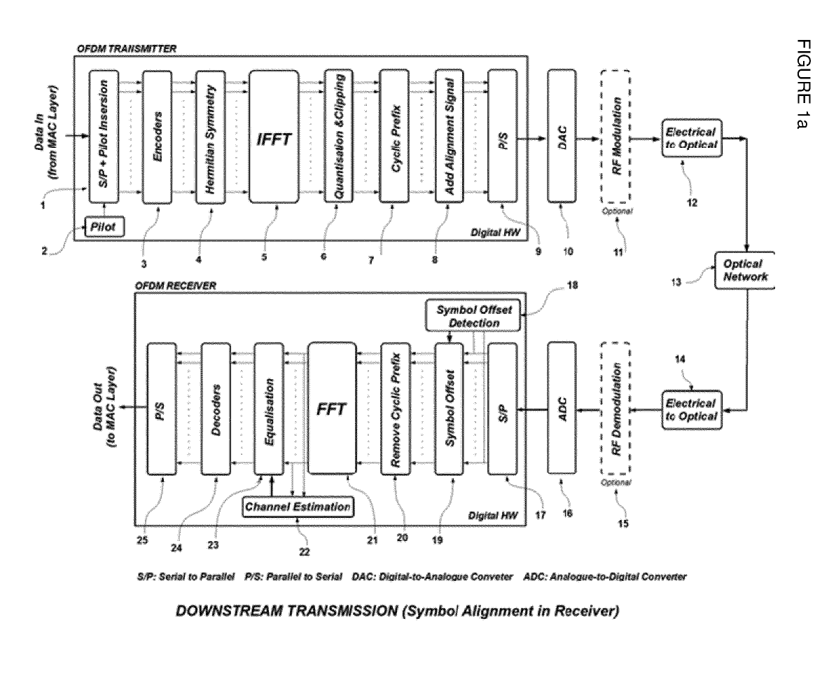

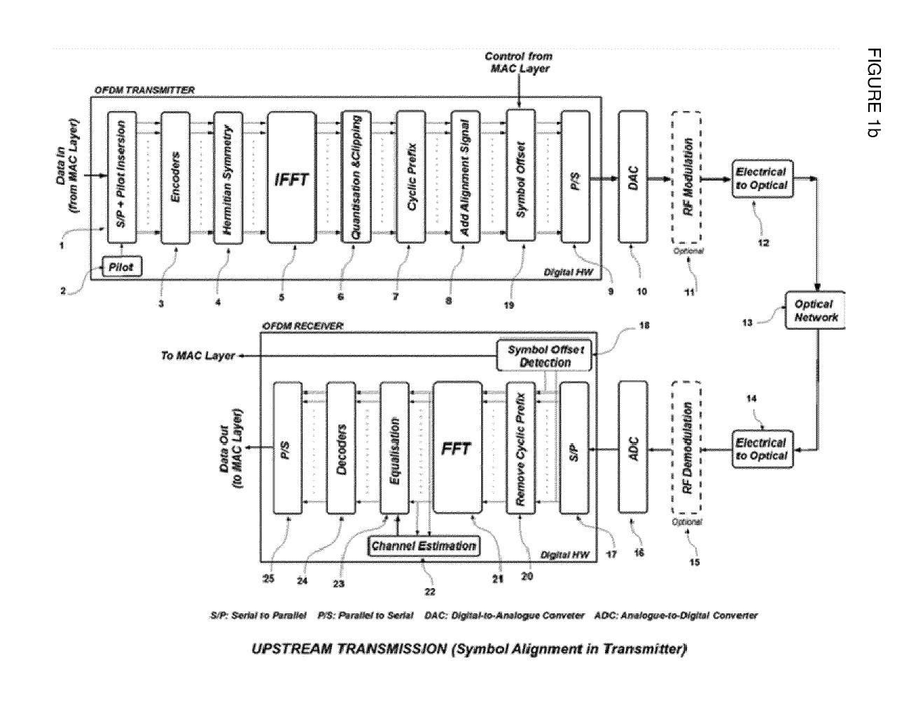

The present method is fully described in FIGS. 1a and 1b.

FIG. 1a shows the system block diagram for the OOFDM downstream link in an optical network. Digital hardware in the transmitter 1-9 generates a sampled digital OFDM signal from the incoming binary payload data from the media access control (MAC) layer. A serial to parallel conversion function 1 converts the serial input data stream(s) to parallel output data and inserts predefined pilot data 2 for use in channel estimation. Encoders 3 map the incoming parallel binary data to multiple complex valued subcarriers using various modulation formats, such as binary phase shift keying (BPSK), quadrature phase shift keying (QPSK), 16 quadrature amplitude modulation (16 QAM)-256 QAM. To generate a real valued output for transmission the encoded complex subcarriers are arranged with Hermitian Symmetry 4 prior to input to the inverse fast Fourier transform (IFFT) function 5 which generates the time domain OFDM signal for each successive OFDM symbol. The symbol samples are then clipped 6 to control the peak-to-average power ratio (PAPR) and quantised to a fixed number of quantisation bits 6. A cyclic prefix is added to the symbol 7 by duplicating the last C symbol samples to the front of the symbol, the value of C being optimised for the system. The low level DC offset is then added to the complete symbol 8 according to the procedure disclosed in the present invention. The parallel symbol samples are then converted to serial samples 9 and fed to a DAC 10 for conversion to an analogue electrical signal. The analogue electrical signal can be optionally modulated onto an RF carrier 11 for use in multi-band OOFDM systems. The electrical signal is converted to an intensity modulated optical signal by a suitable electrical-to-optical converter 12 such as a directly modulated distributed feedback laser (DFB) for example. The optical OFDM signal is transmitted from the optical line terminal (OLT) in the central office, through the optical network to the optical network unit (ONU) at the customer premises.

At the ONU the optical signal is converted to an analogue electrical signal with a direct detection optical-to-electrical converter 14 such as a PIN photodetector. If RF modulation was employed the signal is RF demodulated 15. An ADC 16 converts the analogue electrical signal to a sampled digital signal for processing by digital hardware 17-25. A serial-to-parallel 17 converter first converts the serial samples from the ADC to parallel samples corresponding to one OFDM symbol length with arbitrary symbol alignment. The parallel samples are fed to the symbol offset detection function 18 which detects the symbol offset according to the procedure disclosed in the present invention. The arbitrarily aligned parallel symbol samples are simultaneously fed to a symbol offset function 19 which selects and outputs the appropriate samples aligned to the symbol boundary according to the sample offset determined in 18. In both the symbol offset detection function 18 and the symbol offset function 19 buffering may be employed to ensure sufficient samples are available for the function to operate. The cyclic prefix is removed 20 from the symbol aligned samples and fed to a fast Fourier transform (FFT) function 21 which converts the time domain signal to a discrete frequency domain signal consisting of complex subcarrier coefficients. The channel estimation function 22 detects the subcarriers carrying pilot data at the FFT output in order to estimate the channel transfer function (CTF). The CTF is use by the equalisation function 23 to compensate for the phase and amplitude response of the transmission channel. The equalised frequency domain subcarriers are then decoded 24 to recover the encoded binary data on each subcarrier before the combined parallel binary data is converted to serial data stream(s) by a parallel-to-serial converter function 25. The serial binary data stream(s) are then output to the MAC layer. The pilot data can be removed within the MAC layer or a hardware function can be implemented after the decoders 24 to remove pilot data before passing to the MAC layer.

FIG. 1b shows the system block diagram for the OOFDM upstream link in an optical network where the transmitter is located in the ONU at the customer premises and the receiver is located in the OLT in the central office. The system is identical to the downstream link except the symbol offset function 19 is located in the transmitter hardware in the customer premises ONU and not in the receiver hardware in the OLT. Locating the symbol offset function in the transmitter is necessary to allow all ONUs to achieve OFDM symbol alignment at the OLT. The symbol offset detection function 18 is located in the OLT receiver, the detected symbol offset is then sent to the MAC layer for transmission over a downstream control channel to the ONU. The symbol offset function 19 in the ONU transmitter is adjusted via the MAC layer with the symbol offset value received over the control channel.

For both the downstream and upstream links the system clocking can be achieved using the synchronous clocking technique disclosed in WO2011/141540.

The synchronisation signal may be used without the OOFDM signal if needed, for example, when adding a new optical network unit (ONU) to a multipoint PON system.

The additional symbol alignment signal is transmitted at a low power-level such that it introduces negligible degradation to the OOFDM signal.

The symbol alignment signals can also be made unique to individual OOFDM transceivers such that in a multipoint network topology a limited number of OOFDM transceivers can simultaneously transmit their own symbol synchronisation signals without generating cross-talk or interference between different symbol alignment signals.

The use of a dedicated symbol alignment signal avoids the need to process the noise-like time-domain OOFDM signal for symbol alignment purposes, which requires significantly more processing resources and suffers from relatively slow tracking speeds compared to processing the dedicated alignment signal.

In a first embodiment according to the present invention, symbol alignment is carried out in a point-to-point OOFDM link. The same operating principles also hold in point-to-multi-points cases.

It is known by the man skilled in the art that the effectively low DC signal level over the time duration of one OOFDM symbol does not influence the detection of the transmitted data encoded in the OOFDM symbol's subcarriers. In the present system, the fast Fourier transform (FFT) is used by the receiver to convert the signal from the time domain to the frequency domain. The FFT output at zero frequency (DC) is dependent on the DC level in the time domain. In conventional systems, this information, however, is discarded by the receiver when recovering the encoded data. If any DC level within the symbol period is low enough this will have negligible impact on the performance of the system.

In the following discussions all signals considered are discrete time digital signals, meaning they only have values corresponding to equally spaced discrete sampling points. The digital signals are converted to analogue signals before OOFDM transmission and back to digital signals after transmission. This conversion is immaterial to the operation of the invention.

The sampling interval is defined as ΔT_{I}, and is related to the data region of the OOFDM symbol period (FFT window without cyclic prefix), T_{FFT}. In the OOFDM transmitter the inverse FFT (IFFT) is used to generate the time domain signal from the frequency domain subcarriers. If an N point IFFT is used, there will be N time domain samples generated. ΔT_{I} is therefore equal to T_{FFT}/N, i.e. the data region of the OOFDM symbol period is N samples long.

If a cyclic prefix of length C samples is used the total symbol length is N+C. All time intervals are defined as multiples of ΔT_{I} or simply as an integer multiple of samples, for example 32·ΔT_{I} or 32 samples.

It should be noted that up-sampling and down-sampling may be used such that the sample rate of the transmitted analogue signal is higher than the sample rate achieved with a sampling interval of ΔT_{I}.

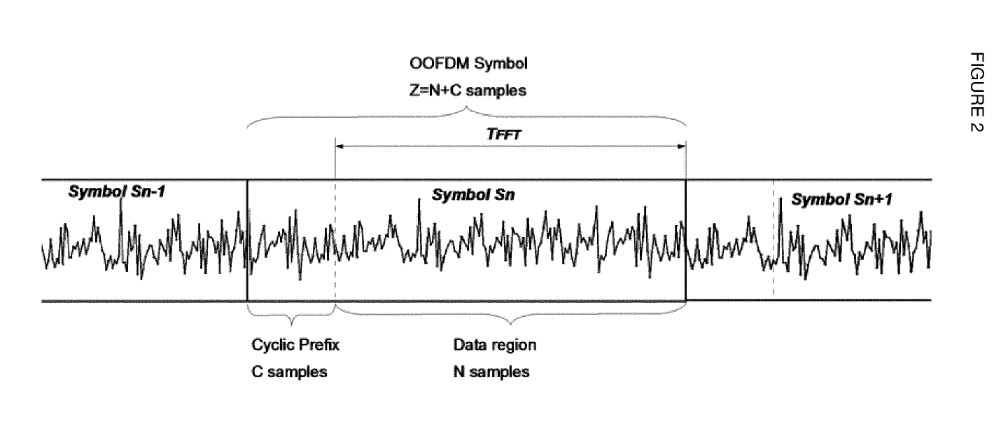

The invention can also operate with higher sample rates in the receiver than in the transmitter but this does not give any known advantage. FIG. 2 illustrates the symbols within an analogue OOFDM signal.

The present invention discloses a method for transmitting a signal from the transmitter that comprises the steps of:
a) encoding the incoming binary data sequence into serial complex numbers using different signal modulation formats;
b) truncating the encoded complex data sequence into a number of equally spaced narrow band data, that is a sequence of symbols S1, S2, . . . , Sn, . . . wherein Sn is the n-th symbol;
c) applying an inverse time to frequency domain transform such as an IFFT for generating parallel complex or real valued time domain samples forming OOFDM symbols;
d) optionally inserting a cyclic prefix C in front of each symbol;
e) adding a DC offset X to each symbol, said DC offset being aligned to the OOFDM signal, wherein X is equal to p1 if n is odd and X is equal to p2 if n is even with the constraint that p1 is not equal to p2. Alternatively X can be a predefined but arbitrary, repeating sequence of p1 and p2 of a fixed length, this being defined as a coded alignment signal.
f) serialising the parallel samples into a long digital sequence;
g) applying a digital to analogue converter to convert the digital sequence into an analogue electrical signal;
h) applying an electrical to optical converter (E/O) to generate an optical signal;
i) coupling the optical signal into a single mode fibre (SMF) or multimode fibre (MMF) or polymer optical fibre (POF) link.

An inverse procedure is used to detect and decode the signal in the receiver which comprises the steps of:
a) receiving the transmitted OOFDM signals with an optical-to-electrical (O/E) converter;
b) applying an analogue to digital converter to convert the analogue electrical signal into a digital sequence of samples;
c) applying a serial-to-parallel converter in order to transform the long serial sequence into parallel data;
d) processing the alignment signal to detect symbol alignment offset and align the selected parallel data to the symbol boundaries;
e) removing the cyclic prefix;
f) applying a direct time-to-frequency domain transform;
g) performing parallel demodulation of the complex valued sub-carriers.

The OOFDM transmitter transmits a sequence of symbols S₁, S₂, . . . Sₙ, Sₙ₊₁, . . . S_{∞} where Sₙ is the nth symbol. The transmitter adds a DC offset X aligned to each symbol according to the following rules:
X=p1 when n is odd
X=p2 when n is even
   |p1−p2|≧quantisation level

The added DC offsets p1 and p2 are of very small amplitudes relative to the OOFDM signal in order not to degrade the system performance. If Y is the peak amplitude of the OOFDM signal X is selected such that X<<Y. X is preferably <Y/20 and more preferably <Y/100 and it is ideally as small as 1 quantisation level.

Preferably X is the same for all odd symbols, with a value of p1 and the same for all even symbols with a value p2. More preferably p2=−p1 and has a size equal to at least 1 quantisation level. It is also possible for any one of p1 or p2 to be equal to zero, the other being equal to p. The effective alignment signal then has a fixed offset of ½·p across all symbols and a varying offset between consecutive symbols of ±½·p.

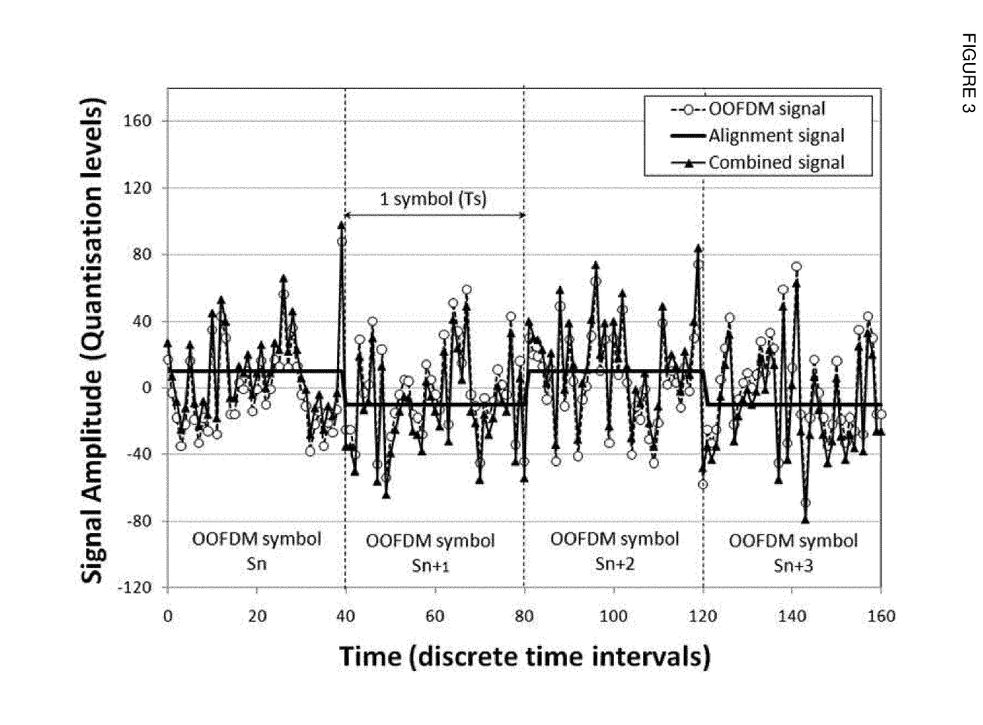

The DC offset signal added to the OOFDM signal is therefore a square wave of peak-to-peak amplitude p1+p2 and period equal to 2(N+C) samples, that is the total period of two OOFDM symbols including cyclic prefix C, if present. The frequency of this square wave is thus half the symbol rate. As the symbol rate is generally high, typically of the order of hundreds of MHz, the square wave's frequency is sufficient to pass through the system, even if it is AC coupled. This additional signal is used in the receiver to detect symbol alignment offset. Throughout this description, it is referred to as the “alignment signal”. FIG. 3 shows an example of the combined OOFDM signal and alignment signal, wherein the amplitude of the alignment signal is exaggerated for easier viewing.

In the receiver the alignment signal does not need to be removed from the received signal as this does not affect the data recovery process. The receiver is preferably clocked such that the symbol period and the signal sampling frequency are close to identical in the transmitter and the receiver. The technique however tolerates a small offset between the transmitter and receiver clocks. As discussed later, the alignment signal can also be used to compensate for an asynchronous receiver clock.

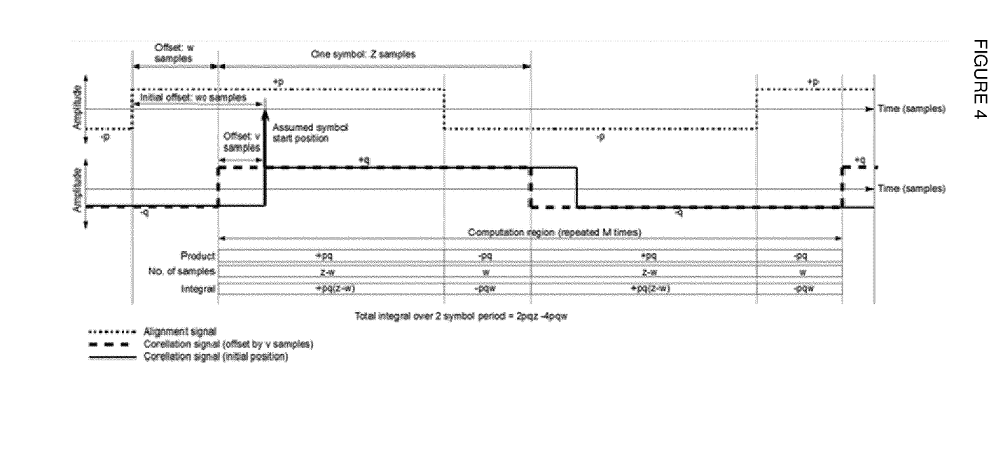

In the receiver, an arbitrary starting position is assumed for the received symbol. This determines the initial symbol offset of w₀ samples between the starting position and the real symbol position as illustrated in FIG. 4. In this drawing, w₀ is defined as the number of samples from the assumed starting position of the received signal to its actual starting position: it can be positive or negative. A positive value indicates that the assumed symbol starting position lags behind the real symbol starting position and vice-versa a negative value indicates that the assumed symbol starting position leads the real symbol starting position.

The offset is necessarily determined to an accuracy of one discrete time interval ΔT_{I}. In addition the initial offset can only take Z=N+C possible values. Thus w₀ is an integer ranging between 0 and Z-1.

To determine the symbol offset the receiver generates a signal similar to the alignment signal, with a peak-to-peak amplitude of q1+q2, a DC level of (q1+q2)/2 and a period equal to 2(N+C) samples. Throughout this description, this signal is called the “correlation signal”. Preferably, q2=−q1 so that the DC level is zero.

The correlation between the received alignment signal and the correlation signal is determined for all possible values of offset, w, wherein w is defined as the offset between a shifted instance of the correlation signal and the alignment signal. The highest positive correlation peak occurs when w equals zero samples, that is when the correlation signal and the alignment signal are fully aligned. Similarly the lowest negative correlation peak occurs when the w=(N+C) samples, that is when the correlation signal and the alignment signal are completely out of phase.

These two correlation peaks are thus used to determine symbol alignment based on the shift in their associated correlation signal relative to the initial correlation signal position.

The algorithm used for computing the initial symbol offset, w₀, relative to the initial arbitrary symbol position comprises the steps of:
1. Aligning the correlation signal to an arbitrary initial symbol position wherein the unknown offset to the actual symbol position is w₀.
2. Modifying the initial correlation signal by adding an incremental offset of v samples to vary the offset w with the alignment signal, as shown in FIG. 4.
3. Processing over a period of 2.M.Z samples:
   The received OOFDM signal D₁, D₂, . . . , D_{2MZ}
   The received alignment signal: A₁, A₂, . . . , A_{2MZ}
   The correlation signal: C₁₊ᵥ, C₂₊ᵥ, . . . , C_{2MZ+v}
   wherein M is a large integer number, preferably ≦2000 or more preferably ≦1000 and v is an offset added to the correlation signal and is an integer of initial value 0.
4. Multiplying the received signal samples Dₖ+Aₖ by the corresponding correlation signal samples Cₖ₊ᵥ over the 2M symbol periods, for k=1 to 2·M·Z and starting with v set to 0, that is starting with the correlation signal at its initial position and generating the resulting correlation value CORₖ=(Dₖ+Aₖ)·Cₖ₊ᵥ
5. Calculating COR_{2M} defined as the sum of all CORₖ samples over the period of 2M symbols according to equation

$${COR}_{2 M} = {\sum }_{k = 1}^{2 MZ} ( {D}_{k} + {A}_{k} ) \cdot {C}_{k + v}$$

6. Deriving INTᵥ as the absolute value of COR_{2M},

INTᵥ=|COR_{2M}|

associated with the correlation signal offset value of v. INTᵥ is referred to as the correlation profile. Each value of the arbitrary starting position w₀ generates a unique profile.
7. Repeating steps 4 to 6 and calculating INTᵥ for all values of v ranging between 0 and Z-1 in order to obtain results for Z correlations performed between the alignment signal and Z offset versions of the correlation signal.
8. Selecting the most positive value from the group of Z values of INTₖ wherein k is ranging from 0 to Z-1.
9. Determining the offset w₀, between the actual symbol positions and the initial position of the correlation signal as equal to the value of v at which the maximum value of INTᵥ occurs, that is:

w₀=v at max [INTᵥ] for v ranging between 0 and Z-1

Once the initial offset w₀ is determined the OOFDM signal is delayed by w₀ samples, either in the transmitter or receiver, in order to align the received OOFDM signal with the initially assumed symbol positions, so that the groups of Z samples extracted for data recovery in the receiver originate from the same symbol.

An understanding of the mechanism behind the present invention can be gained if INTᵥ is rewritten as

$${INT}_{V} = \vert {\sum }_{k = 1}^{2 MZ} {D}_{k} \cdot {C}_{k + v} + {\sum }_{k = 1}^{2 MZ} {A}_{k} \cdot {C}_{k + v} \vert$$

The first term on the left hand-side of the above equation, Dₖ·Cₖ₊ᵥ, is the product of the OOFDM data signal and the correlation signal, both of which have zero mean value and are uncorrelated. Their product thus also has zero mean value if calculated over a sufficiently long period. If M is large enough, the first sum on the right hand-side of the above equation thus tends to zero, and INTᵥ reduces to

$${INT}_{V} = \vert {\sum }_{k = 1}^{2 MZ} {A}_{k} \cdot {C}_{k + v} \vert$$

FIG. 4 illustrates the calculation of INTᵥ over a period of 2 symbols where the offset between the correlation signal and the alignment signal is w samples, where w is positive or negative. It shows that for M=1, INTᵥ has the value |2·p·q·Z−4·p·q·|w∥, when calculated over 2M symbols this becomes:

INTᵥ=|2·M·p·q·Z−4·M·p·q·|w∥

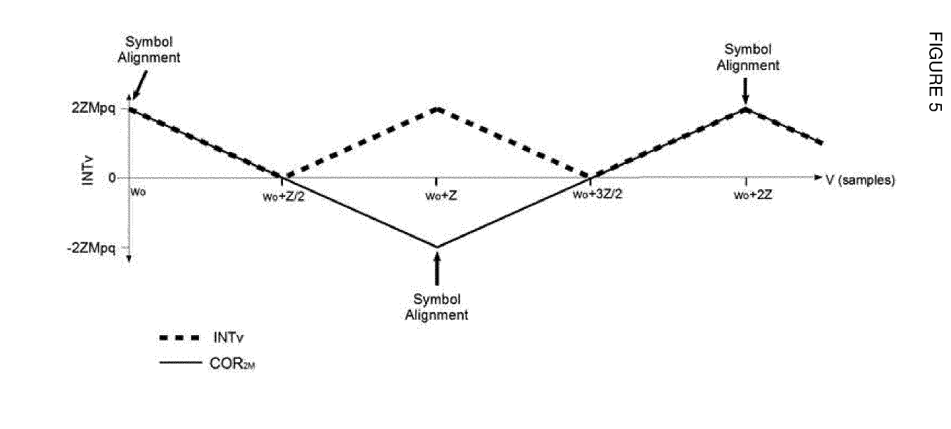

As the correlation signal offset v is incrementally varied the offset w will also vary causing the cyclic variation in INTᵥ with v, as shown in FIG. 5. As w can only have values between ±Z as it is cyclic and as INTᵥ depends only on the magnitude of w, INTᵥ is cyclic with a period of Z, as illustrated in FIG. 5. INTᵥ has peak values at w=0, i.e. at v=w₀ and w=±Z, i.e. v=w₀±Z. By varying v from 0 to Z-1 a peak will be detected at either v=w₀ for positive values of w₀, or at v=w₀+Z for negative values of w₀. The position of the peak in the graph of INTᵥ as a function of v defines the value of v corresponding to the offset between the assumed initial symbol position and the actual symbol position. The symbol location is thus determined with respect to the assumed initial position.

FIG. 5 also shows how COR_{2M} varies with the correlation signal offset v. As the alignment signal and the correlation signal have a period of 2Z the period of COR_{2M} is also 2Z, giving it 2Z possible values. There are however only Z possible offset values. COR_{2M} has its positive peak when the v=w₀ i.e. when the alignment and correlation signals are in phase, and it has its negative peak when v=w₀±Z i.e. when the alignment and correlation signals are out of phase. Both of these peaks are valid as an offset of Z samples does not change symbol alignment. Therefore, instead of calculating INTᵥ and detecting the single positive peak, COR_{2M} can be calculated for v=0 to Z-1 and either a positive or negative peak detected. Using INTᵥ provides a simpler way to detect the peak as the peak is then always positive.

The following points should be highlighted with regard to the implementation of the technique.
The technique is totally independent of the cyclic prefix length selected and allows any length of cyclic prefix, including 0 samples. The only restriction is that the alignment signal must have a constant value for the total symbol period.
If the transmitted alignment signal does not have a zero DC level, that is if |p1| and |p2| have arbitrary different values, this does not affect operation, the restriction is that the DC level is sufficiently low to prevent OOFDM signal distortion. It must be noted that the optical signal has a DC bias level as the optical power can only be positive, and that any DC offset present in the alignment signal thus cannot be distinguished from the DC bias level. In addition, the DC level does not need to be removed at the receiver as it does not influence the correlation result: indeed there is no correlation between the correlation signal and a DC level for any symbol offset.
In the digital domain, before conversion to the analogue optical signal, the smallest amplitude for the alignment signal is ±0.5 quantisation levels. This can for example be achieved by setting the offset during even symbols to 1 quantisation level and during odd symbols to 0 quantisation levels. This also adds a fixed offset of 0.5 quantisation levels to the alignment signal of amplitude ±0.5 quantisation levels. This fixed offset however does not affect operations.
In the simplest method, the peak of the correlation profile is selected as the maximum value. Alternatively, and in order to detect the peak more accurately, especially when the profile is noisy, it can be further processed by making use of the fact that the profile is cyclic and thus symmetric about the peak.

The invention can be used to achieve asynchronously clocked OOFDM receivers by compensating for the sampling clock offset (SCO) which is the difference between the transmitter sampling clock frequency and receiver sampling clock frequency. SCO degrades the performance of the system due to imperfect sampling of the received OOFDM signal. A certain amount of SCO can be tolerated if symbol alignment is maintained. If there is no automatic symbol alignment the SCO causes the symbol alignment offset to increase over time, the speed of the offset drift being proportional to the SCO.

If the receiver is implemented such that the symbol alignment offset is continuously tracked and corrected when it drifts by ±n samples, this maintains symbol alignment to an accuracy of ±n samples. If the cyclic prefix is long enough and the FFT window, which is the part of the symbol used for recovering data, is suitably positioned, the receiver can tolerate a variation in symbol alignment of ±m samples, where m is an integer, without degradation in performance.

By selecting a suitable length of cyclic prefix and allowing for the maximum expected inter-symbol interference (ISI), m can be set to ±1 or more. Ideally, m is ±1 in order to maximise net data rate by selecting a very short cyclic prefix.

To avoid ISI n must be ≦m, and n can be as low as 1 with the present symbol alignment technique as an offset to a resolution of 1 sample can be detected. As the symbol offset drifts between 0 and ±1 sample, before symbol realignment, the effective phase shift introduced to the subcarriers cannot be distinguished from channel induced phase shift. It is thus compensated by the channel estimation and equalisation function of the OOFDM receiver.

The present technique is implemented by processing of the OOFDM signal after it is converted to the electrical domain and quantised to digital samples. Preferably, the samples have a resolution of at most 8 bits. Processing of sampled digital signals, known as digital signal processing (DSP), can be either software based, using a microprocessor and memory, or hardware based logic such as FPGA or ASIC, or a combination of both software and hardware. As this invention is applied to high speed optical signals with sample rates of the order of several GS/s and as high speed processing is required the hardware based approach is preferred. High speed microprocessors can however be employed, either alone or in combination with hardware.

The algorithm described above in points 1 to 9 can be implemented in several different ways depending upon the complexity, speed and memory requirements of the system. One may for example use the following approaches.
Serial processing:
Each sample is processed on a one by one basis, in a serial manner. Each received sample is multiplied by the corresponding correlation signal sample and its value sent to an accumulator which sums all the products over the required 2M symbols to produce the value COR_{2M} corresponding to the tested offset v. The calculation of the INTᵥ values and w₀ are not dependent on the sample rate. This approach requires very low memory as it stores only one sample at a time. Samples must however be processed at the sample rate.
Under-sampled serial processing:
To reduce the processing speed required for the serial processing approach the serial samples captured for processing can be taken from different symbols. The delay between captured samples must be (μ·2·Z)+1 samples where μ is an integer value. This can be achieved because the alignment signal is periodic with a period of 2·Z. For this approach one sample is stored at a time as for the previous approach and samples are processed at a rate of 1/(2·μ) times the symbol rate wherein μ can be as small as 1 or as large as 1000 or more. Large values of μ reduce the required processing speed but will lead to longer synchronisation times.
Parallel processing:
2M symbols are processed for each tested correlation signal offset, and thus all 2MZ samples could be captured, stored in memory and subsequently processed. The multiplication by the correlation signal samples can be performed in parallel, using 2MZ multipliers, and the summing function operated on the generated parallel values. This approach requires a large amount of memory to store all 2MZ samples. M is preferably very large, of at least 1000, and thus large memory is required, but the sample processing speed is reduced as each parallel sample is processed at a rate of 1/(2M) times the symbol rate. The 2MZ stored samples can also be processed one by one as in the serial processing approach. There can also be a delay between the captured groups of 2MZ samples, of any multiple of 2 symbols, in order to increase the processing time available to process each group.
Semi-Parallel processing:
An alternative approach is to capture the samples from a sequential group of length α symbols in parallel, where α is an even integer, preferably <100. Each sample is processed in parallel and the summation performed in parallel. The summation is repeated for (2·M)/α sample groups and the result fed to an accumulator to produce a summation over 2·M·Z samples. Again a delay can be introduced between captured sample groups, said delay being any multiple of 2 symbols. Also the samples in each captured sample group can be processed one by one. For this approach α·Z samples must be stored at once: this allows memory requirement to be controlled by the value of α. Without delay between sample group captures, the parallel samples must be processed at a rate of α/(2·M) times the symbol rate. α is therefore used in order to trade off memory requirement against processing speed.

The order of the operations within the algorithm can also be modified to possibly provide reduced complexity or to relax memory requirements due for example to fewer bits required to store computed values. In the different approaches described above the captured samples first undergo a multiplication before the summation is performed. However, the summation can be performed before the multiplication when a parallel summation is performed. Samples located 2 symbols apart in the received signal must be multiplied by the same correlation signal sample, therefore these samples can first be summed and the result multiplied by the correlation signal sample. In this way if ε samples are to be processed the number of multiplications is reduced from ε to 1, and the values input to the summation function are smaller in size requiring fewer storage bits. This approach of summation followed by multiplication can be considered as an averaging of the received signal samples spaced 2 symbols apart to remove the OOFDM signal and amplify the alignment signal, before performing the correlation.

In another embodiment according to the present invention the symbol alignment is used in point-to multipoint OOFDM links.

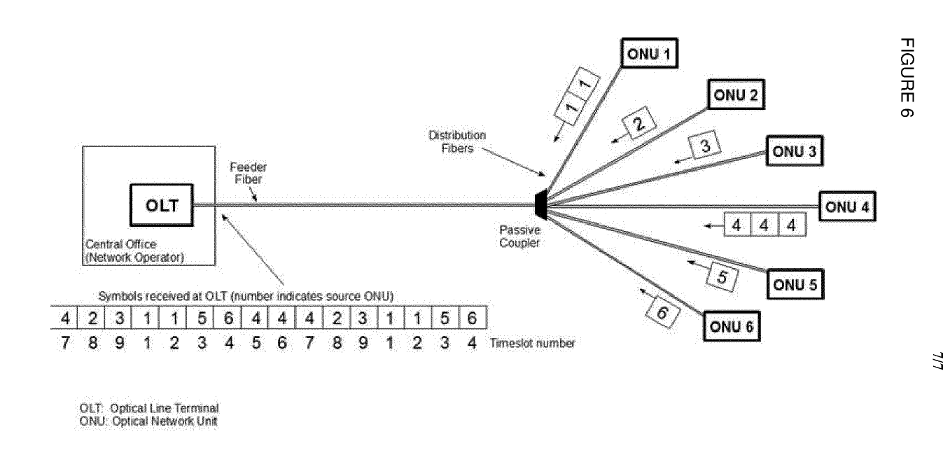

The present embodiment is illustrated in FIG. 6 representing a simple single wavelength OFDMA-PON. The upstream traffic is going from the multiple transceivers in the user premises, the Optical Network Unit (ONU) terminals, to the single transceiver in the network operator's central office, the Optical Line Terminal (OLT).

In the downstream direction the OLT generates aligned OOFDM symbols and all ONUs receive all OOFDM symbols. Each ONU thus detects the location of the OFDM symbols exactly as is done in the case of a point-to-point link.

For the upstream direction the timing of the symbols from each ONU must be adjusted so that they all achieve symbol alignment at the power splitting point and thus at the OLT. Timeslots and subcarriers must also be assigned to all ONUs in order to prevent transmission collisions between different ONUs' data, that is to ensure that only one ONU transmits on a certain number of subcarriers within each OOFDM symbol.

In order to implement upstream OOFDMA-PON symbol alignment, the following basic criteria are assumed.
The length of a timeslot can be any multiple of symbol periods. The minimum length is one symbol and the maximum length is not limited by the synchronisation technique.
An OOFDMA frame is a group of timeslots of fixed length, with timeslots numbered sequentially so that common timeslots positions can be identified between ONUs.
The allocation of bandwidth between ONUs can be selected either in the time domain only as timeslots, or in the frequency domain only as subcarriers or in a combination of both.
The solution is also applicable to wavelength division multiplexed (WDM)-based PONs, where each wavelength provides virtual point-to-point links, and WDM-OOFDMA-based PONs where one or more wavelengths are shared by multiple ONUs in a point-to-multipoint topology.
For OOFDMA-PONs using WDM, symbol alignment is required between ONUs sharing the same wavelength. If each ONU has a dedicated wavelength symbol alignment between ONUs is not required.
The upstream and downstream transmission can be achieved for example by separate fibres or by any method for bidirectional transmission in a single fibre.
The DAC resolution in the ONU transmitter is typically at least 8 bits, and preferably no more than 12bits. This has practical implications on the alignment signal of ONUs as illustrated by the following example. The smallest amplitude of the alignment signal, corresponding to 1 quantisation level is (1/255)·A, where A is the maximum transmitter peak-to-peak (PTP) output for an 8 bit DAC. Assuming equal distribution fibre losses for a PON having for example 32 ONUs, the combined alignment signals received by the OLT have a maximum PTP value of A·L/8, where L is the absolute value of the total fibre attenuation from ONU to OLT (for example, L=0.1 for 90% loss). A·L is thus the maximum PTP value of the signal from any ONU when received at the OLT. This maximum level of the combined alignment signal is clearly too high and will severely interfere with the OOFDM signals. In conclusion, only one ONU can transmit an alignment signal at any time.
There exists a control channel embedded in the data stream from OLT to ONUs to allow the OLT to control parameters in each ONU. Each ONU must therefore have a unique ID or address so that it can be distinguished from other ONUs on the network. There may also be a control channel from each ONU to the OLT. For the symbol synchronisation method only the downlink control channel is required. The control channel can be used to control the symbol alignment offset in the ONUs but is also essential in PONs for functions such as dynamic bandwidth allocation (DBA) by dynamically allocating the timeslots and subcarriers to each ONU.

The symbol alignment in the upstream direction for the OFDMA-PON is based on the principle of the point-to-point solution. The OLT however controls the alignment sequence in order to prevent all ONUs transmitting the symbol alignment signal simultaneously.

The basic protocol used to achieve symbol alignment of the point-to-multipoint PON is defined as follows:
1. The OLT continuously transmits an alignment signal and each ONU aligns to the received symbol positions when initialising.
2. An ONU then waits for the OLT, via the downstream control channel, instruction to transmit an alignment signal. When instructed, the ONU transmits the alignment signal.
3. The OLT detects the offset from the required symbol alignment and instructs the ONU to offset its transmitted symbol position accordingly to align it with the OLTs required received symbol positions.
4. The OLT verifies alignment of the received symbols and instructs the ONU to turn off the alignment signal.
5. The OLT must know the address of each ONU connected to the PON and synchronise each ONU's symbols in turn using steps 2-4.
6. When all ONU are in symbol alignment, the OLT will repeatedly check the alignment of each ONU in turn and instruct an ONU to adjust its symbol offset if necessary.

This alignment protocol can also be employed to achieve symbol synchronisation of new ONUs as they are deployed in an operational PON. The OLT is manually configured to include the new ONU into the synchronisation scheduling.

The OLT must also assign timeslots and/or subcarriers to each ONU to share the bandwidth between the ONUs. The ONU frames must be aligned at the OLT to avoid timeslots from different ONUs colliding at the OLT. An ONU only needs to align to the frame to then be able to identify any given timeslot. To achieve frame alignment the OLT first instructs the ONU to transmit the simple square wave alignment signal and achieve symbol alignment by detecting and compensating the symbol offset. The OLT then instructs the ONU to transmit an alignment signal which now has a period equal to the frame length of L symbols, where L is an integer. The sequence of symbol offsets can be, for example, L_{NEG} symbols with offset of p1 followed by L_{POS} symbols with offset of p2. To make the period of the alignment signal L symbols, L_{NEG}+L_{POS}=L must be satisfied. Other offset sequences of p1 and p2 can be used if the period is L symbols. The OLT then detects the frame offset, in symbols, in a similar manner to the symbol alignment offset detection. For frame alignment only one sample needs to be taken from each successive symbol over a period of L symbols, this sequence of L samples is then used for the correlation process in a similar manner to that used for the symbol alignment. The integration function must be performed over a total signal period equivalent to R frames, or R·L symbols, where R is an integer and is large enough for the OOFDM signals from other ONUs to integrate to zero, R is preferably ≦5000 and more preferably ≦1000. A matching correlation signal, with one sample per symbol, is generated in the OLT which is initially aligned to the frame, the correlation signal offset is incremented by one symbol at a time and the corresponding correlation profile generated over the range of L possible symbols offsets from 0 to L-1. The peak in the correlation profile will indicate the offset between the frame initially assumed by the ONU and the frame alignment required in the OLT. The OLT then instructs the ONU to stop transmitting the frame alignment signal and sends the detected frame offset so that the ONU can identify the start of the frame and therefore all timeslot locations.

By coding the alignment signal from the OLT, it is also possible to introduce a level of security into the network in order to allow only those ONUs that know the alignment signal code to achieve symbol, timeslot and frame synchronisation.

Any unauthorised ONU trying to access transmitted data must know the code to achieve synchronisation and also be able to detect when synchronisation is achieved.

The alignment signal can be a coded sequence of symbol offsets with values of p1 or p2 with a period T_{CODE}=2M/β symbols where β is an integer, preferably ranging from 25 to 75. The symbol alignment principle is exactly the same for the coded sequence as for the simple on-off sequence. Using a sequence that is not periodic within the correlation period (β=1) of 2M symbols restricts however the possibility of performing summation functions before the multiplication functions.

If the code length, T_{CODE}, is sufficiently long, preferably of at least 30 symbols, more preferably of at least 40 symbols, the time taken by a potential offender to determine the code, based on the amount of samples required, by testing all possible permutations of code length, code sequence and possible offset would be prohibitively large.

The present technique is characterised by several advantages, which are summarised below:
Simplicity and high accuracy. The technique does not require any additional hardware, large FPGA logic usage, extra transmission bandwidth, or expensive optical/electrical components. The capability of compensating both SCO and STO effects ensures the high performance accuracy of the technique.
High operation speeds. The technique is suitable for OOFDM optical transmission systems at any arbitrary bit rate.
Wide flexibility. The technique can be implemented in both point-to-point and point-to-multipoint OOFDM transmission systems.
Added physical layer network security. The technique offers an effective means of making communications by an unauthorised user virtually impossible.
Excellent compatibility with existing network architectures and services.
Live upgrading ability without introducing any disruption to existing network architectures and services.

1. A method for symbol synchronization in high speed optical orthogonal frequency division multiplexing (OOFDM) transmission systems comprising:
a) coding electrical OFDM symbols by adding an independent low power-level alignment signal; and
b) converting the coded OFDM signal into the optical domain via E/O converters.

2. The method of claim 1 wherein the OFDM and independent low-power level alignment signals are generated and transmitted from a transmitter of the OOFDM transmission system by the steps of:
a) encoding the incoming binary data sequence into serial complex numbers using the same or different signal modulation formats;
b) truncating the encoded complex data sequence into a number of equally spaced narrow band parallel subcarriers, wherein different subcarriers may have the same or different powers;
c) applying an inverse time to frequency domain transform such as an inverse fast Fourier transform (IFFT) for generating parallel complex or real valued time domain samples forming OOFDM symbols: symbols S1, S2, . . . , Sn, . . . wherein Sn is the nth symbol;
d) optionally inserting a cyclic prefix , of length C samples, in front of each symbol;
e) adding the alignment signal that is a DC offset X to each symbol, said DC offset being aligned to the OFDM symbol, wherein X is equal to p1 if n is odd and X is equal to p2 if n is even with the constraint that p1 is not equal to p2;
f) serialising the parallel symbols into a long digital sequence;
g) applying a digital to analogue converter to convert the digital sequence into analogue waveforms;
h) applying an electrical to optical converter (E/O) to generate an optical waveform;
i) coupling the optical signal into a single mode fibre (SMF) or multimode fibre (MMF) or polymer optical fibre (POF) link.

3. The method of claim 2 wherein in step e) X is a predefined but arbitrary, repeating sequence of p1 and p2 of a fixed length, this being defined as a coded alignment signal.

4. The method of claim 2 wherein, in the transmitter, the low-power level signal transmitted with and aligned to the OOFDM signal are DC offsets X, wherein X is different for 2 consecutive OOFDM symbols and wherein the difference between 2 consecutive DC signals X is of at least 1 quantisation level.

5. The method of claim 2 wherein X Is the same +p for all even numbered symbols, and the same −p for all odd numbered symbols, wherein p is at most Y/20 wherein Y is the peak amplitude of the OOFDM signal.

6. The method of claim 5 wherein p is at most Y/100.

7. The method of claim 1 wherein the alignment signal has a coded pattern in order to introduce an extra level of physical layer security Into the network.

8. The method of claim 2 wherein, in the a receiver of the OOFDM transmission system, the signal is received and decoded by the steps of:
a) receiving the transmitted OOFDM signals with an optical-to-electrical converter (O/E);
b) applying an analogue to digital converter to convert the analogue waveform into a digital sequence of samples;
c) applying a serial-to-parallel converter in order to transform the long serial sequence into parallel data;
d) processing the receiver-generated combined OFDM signal and alignment signal to detect symbol alignment offset and align the selected data to the symbol boundaries;
e) removing the cyclic prefix if present;
f) applying a direct time-to-frequency domain transform;
g) performing parallel demodulation of the complex valued sub-carriers.

9. The method of claim 1 wherein the alignment signal is processed in a receiver of the OOFDM transmission system by the steps of:
a) generating a correlation signal similar to the alignment signal;
b) aligning the correlation signal to an arbitrary initial symbol position wherein the unknown offset to the actual symbol position is w₀;
c) modifying the initial correlation signal by adding an incremental offset of v samples;
d) processing over a period of 2.M.Z samples:
The received OOFDM signal D₁, D₂, . . . , D_{2MZ}
The received alignment signal: A_{1I}, A₂, . . . , A_{2MZ}
The correlation signal: C₁₊ᵥ, C₂₊ᵥ, . . . , C_{2MZ+v}
wherein M is a large integer number of preferably at most 2000 and v is the offset added to the correlation signal and is an integer of initial value 0;
e) multiplying the received signal samples Dₖ+Aₖ by the corresponding correlation signal samples Cₖ₊ᵥ over the 2M symbol periods, for k=1 to 2·M·Z and starting with v set to 0, to generate a correlation value CORₖ=(Dₖ+Aₖ) Cₖ₊ᵥ;
f) calculating COR_{2M} defined as the sum of all CORk samples over the period of 2M symbols according to equation
$${COR}_{2 M} = {\sum }_{k = 1}^{2 MZ} ( {D}_{k} + {A}_{k} ) \cdot {C}_{k + v}$$
g) deriving INTᵥ as the absolute value of COR_{2M},
INTᵥ=|COR_{2M}|

associated with the correlation signal offset value of
h) repeating steps d) to g) and calculating INTᵥ for all values of v ranging between 0 and Z-1;
i) selecting the most positive value from the group of Z values of INTₖ wherein k is ranging from 0 to Z-1; and
j) determining the offset w₀, between the actual symbol positions and the initial position of the correlation signal as
w₀=v at max [INTᵥ] for v ranging between 0 and Z-1

10. The method of claim 9 wherein the algorithm can be implemented in any one of serial processing, under-sampling serial processing, parallel processing or semi-parallel processing.

11. The method of claim 1 further comprising:
compensating for a sampling clock offset in asynchronously clocked OOFDM receivers.

12. The method of claim 1 further comprising:
applying the symbol synchronization in point to multipoint OOFDM links.

13. The method of claim 1 further comprising:
applying the symbol synchronization to achieve-physical layer network security.

14. A media access control layer protocol achieving symbol alignment in point-to-multipoint Passive Optical Networks (PONs) that comprises:
a) An Optical Line Terminal (OLT) continuously transmitting an alignment signal and each Optical Network Unit (ONU) aligning to the received symbol positions when initialising;
b) An ONU then waiting for the OLT, via the downstream control channel, instruction to transmit an alignment signal, and when instructed, transmitting the alignment signal;
c) The OLT detecting the offset from the required symbol alignment and instructing the ONU to offset its transmitted symbol position accordingly to align it with the OLTs required received symbol positions;
d) The OLT verifying alignment of the received symbols and Instructing the ONU to turn off the alignment signal;
e) The OLT knowing the address of each ONU connected to the PON and synchronising each ONU's symbols in turn using steps b-d;
f) When all ONU are in symbol alignment, the OLT repeatedly checking the alignment of each ONU in turn and instructing an ONU to adjust its symbol offset if necessary; and
g) Employing the alignment protocol to achieve symbol synchronization of new ONUs optionally deployed in an operational PON, wherein the OLT is manually configured to include the new ONU into the synchronization scheduling.
